(19) United States
(12) Patent Application Publication
(10) Pub. No.: US 2010/0061355 A1
(43) Pub. Date: Mar. 11, 2010

(54) COMMUNICATION TERMINAL, COMMUNICATION SYSTEM AND DETERMINATION METHOD

(75) Inventor: Hitoshi Tsuchiya, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/555,652

(22) Filed: Sep. 8, 2009

(30) Foreign Application Priority Data
Sep. 8, 2008 (JP) 2008-229757

(51) Int. Cl. H04B 7/00

(52) U.S. Cl. 370/338; 370/310

(57) ABSTRACT

A communication terminal comprising: a determination unit which determines whether or not the communication terminal is able to connect to a first external terminal using a wireless communication, based on a communication condition of wired or wireless communication with a second external terminal which is different from the first external terminal, when the communication terminal receives a connection request from the first external terminal.

### BACKGROUND OF THE INVENTION

1. Field of the Invention

The present invention relates to a communication terminal, a communication system, and a determination method.

Priority is claimed on Japanese Patent Application No. 2008-229757 filed on Sep. 8, 2008, the contents of which are incorporated herein by reference.

2. Description of Related Art

A WPS (Wi-fi Protected Setup) is defined as a standard which simply sets a connection of a wireless LAN (Local Area Network), and the WPS is spreading recently. One example of this system, there is a PBC (Push Button Configuration). In the PBC, buttons for establishing a connection are provided with both a terminal, which connects to the wireless LAN, and an access point (e.g. router). When a user presses both buttons, settings are performed automatically for terminals whose buttons were pressed, and the terminal is enabled to connect to the wireless LAN. In addition, for example, a technology about using a button and setting a wireless LAN is disclosed in Japanese Unexamined Patent Publication, First Publication No. 2004-215232.

By the way, as a connection mode of the wireless LAN, there are two modes. One mode is an infrastructure mode wherein a plurality of terminals is connected to each other through an access point. Another mode is an ad hoc mode wherein a plurality of terminals is connected directly to each other. The PBC relates to a connection of WPS of the infrastructure mode.

### SUMMARY OF THE INVENTION

In accordance with one aspect of the present invention, a communication terminal comprises a determination unit which determines whether or not the communication terminal is able to connect to a first external terminal using a wireless communication, based on a communication condition of wired or wireless communication with a second external terminal which is different from the first external terminal, when the communication terminal receives a connection request from the first external terminal.

### BRIEF DESCRIPTION OF THE DRAWINGS

FIG. 1 is a block diagram showing a configuration of a communication terminal according to one embodiment of the present invention.

FIG. 2 is a reference figure showing a state of a connection of an ad hoc mode according to one embodiment of the present invention.

FIG. 3 is a reference figure showing a state of a connection of an infrastructure mode according to one embodiment of the present invention.

FIG. 4 is a sequence diagram showing a connection process between communication terminals according to one embodiment of the present invention.

FIG. 5 is a flowchart showing a determination process which is performed by a communication terminal according to one embodiment of the present invention.

FIG. 6 is a flowchart showing a determination process which is performed by a communication terminal according to one embodiment of the present invention.

FIG. 7 is a reference figure for explaining a process to determine a registrar or an enrollee, based on a combination of connection conditions of a communication terminal according to one embodiment of the present invention.

FIG. 8 is a sequence diagram showing a connection process between communication terminals according to a PBC.

### DETAILED DESCRIPTION OF PREFERRED EMBODIMENTS

Hereunder is a description of an embodiment of the present invention with reference to the drawings. At first, a WPS is explained.

In the WPS, a plurality of modes is defined, for example PIN, PBC, UFD and NFC. This embodiment corresponds to the PBC. The PBC is a mode wherein an authentication or a variety of settings is performed automatically, when a user presses buttons for establishing a connection. The buttons are provided with both terminals that the user wants to establish the connection each other.

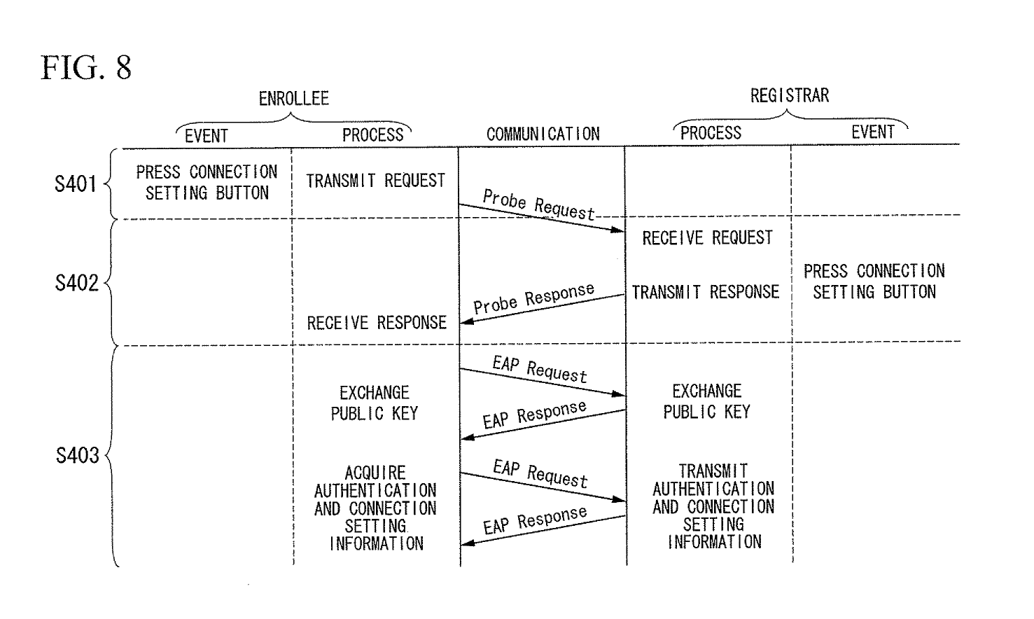

FIG. 8 shows a normal connection process according to the PBC. All communications in FIG. 8 are performed using the wireless communications. A registrar in FIG. 8 is a terminal which provides setting information which relates to an authentication or a network connection. In the infrastructure mode, in most cases, a router behaves as a registrar. An enrollee is a terminal (a terminal which transmits an EAP Request) which requires an authentication, when the terminal is connecting to another terminal using the wireless communication.

Hereunder is a description of processes represented by FIG. 8. When a button for connecting, which is provided with the enrollee, is pressed, the enrollee generates a probe request, and transmits it to the registrar (Step S401). The probe request indicates that a connection request of wireless communication has been sent from the enrollee to the registrar. The registrar receives the probe request. When the button for connecting (the button is provided with the registrar) is pressed, the registrar transmits a response (probe response) to the enrollee (Step S402). Afterwards, processes (for example, process of exchanging of a public key, process of performing an authentication) are performed (Step S403), and a connection setting is completed.

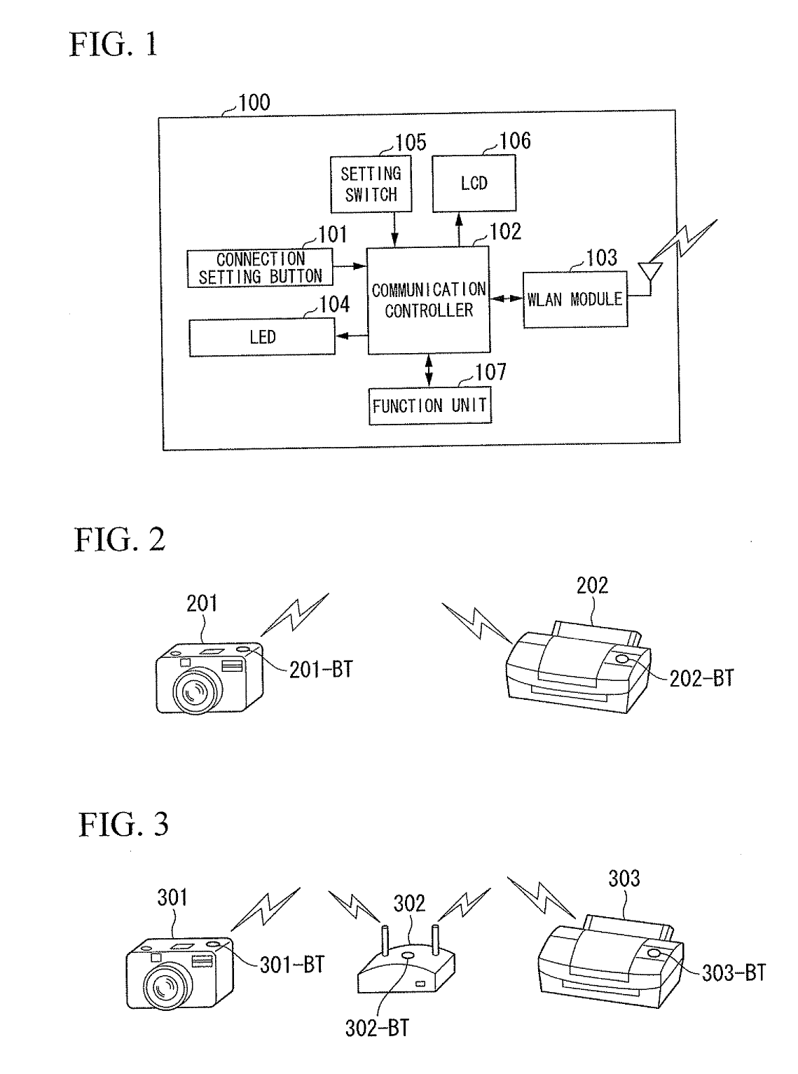

Next, the embodiment of the present invention is explained. FIG. 1 shows a configuration of a communication terminal according to the embodiment of the present invention. A communication terminal 100 comprises a connection setting button 101, a communication controller 102, a WLAN module 103, an LED 104, a setting switch 105, an LCD 106, and a function unit 107.

The connection setting button 101 is a button for inputting an instruction from a user, and is used to set a connection of a wireless LAN. When the user presses the connection setting button 101, the connection setting button 101 sends a notification to the communication controller 102. The notification indicates that the user pressed the button. The communication controller 102 performs various controls (for example, control of date communication, irradiating (emitting) of the LED 104, display control of the LCD 106, setting an operation mode according to the setting switch 105) performed by the communication terminal 100.

The WLAN module 103 performs a transmitting and receiving of data with another communication terminal, which is not illustrated, using the wireless communication. In other words, the WLAN module 103 transmits data, which is output from the communication controller 102, to the other communication terminal through an antenna. In addition, the WLAN module 103 receives data, through the antenna, transmitted by the other communication terminal, and outputs the data to the communication controller 102.

The LED 104 irradiates depending on various conditions of a connection. In this embodiment, especially, when the connection setting button 101 is pressed, and the communication terminal 100 is setting a connection, the LED irradiates to the user. The user is able to understand that a connection is going to be established. The setting switch 105 is a switch that the user inputs instructions to set variously to the communication terminal 100. The LCD 106 displays various conditions in regard to the communication terminal 100.

The function unit 107 performs different processes according to a function of the communication terminal 100. For example, if the communication terminal 100 is a camera, the function unit 107 is an image pickup apparatus, if the communication terminal 100 is a printer, the function unit 107 is a printing apparatus.

FIG. 2 shows an example of a connection of the ad hoc mode. A camera 201 and a printer 202 corresponding to the communication terminal 100 are connected directly to using a wireless LAN. In this case, at a timing of a setting of a connection, if the user presses both the connection setting button 201-BT of the camera 201, and connection setting button 202-BT of the printer 202, a connection between the camera 201 and the printer 202 is completed.

In this embodiment, if the user presses the connection setting button 201-BT of the camera 201, the connection setting button 202-BT of the printer 202 irradiates automatically. Therefore, the user is able to know that a connection will be established, if the user presses the connection setting button 202-BT. A detailed example of this is described below. The connection setting button 201-BT and 202-BT are configurations that the connection setting button 101 is united with the LED 104. Therefore, the user is able to understand more easily that if the user presses the connection setting button 201-BT and 202-BT, a connection will be established.

FIG. 3 shows an example of a connection of the infrastructure mode. A camera 301 is connected to a printer 303 by way of a router 302. Each of the camera 301, the router 302 and the printer 303 corresponds to the communication terminal 100. In this case, at a timing of a setting of a connection, if the user presses a connection setting button 301-B of the camera 301, a connection setting button 302-BT of the router 302 irradiates, but a connection setting button 303-BT of the printer 303 does not irradiate. This is because the printer 303 uses a port of a wireless LAN for an infrastructure connection with the router 302. A detailed example of this is described below. As described above, in the case illustrated in FIG. 3, the user is able to know that a connection will be established, if the user presses the connection setting button 302-BT of the router 302.

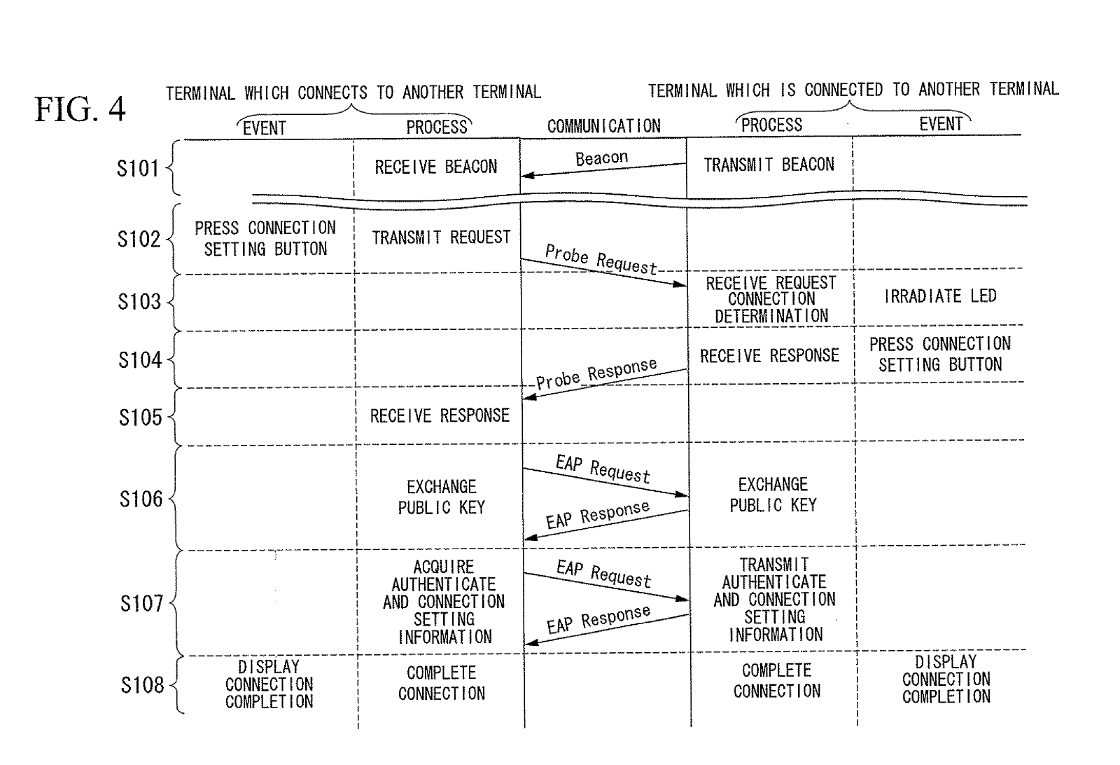

Next, a connection process between two communication terminals is explained with reference to FIG. 4. Hereunder, a terminal which connects another terminal is the camera 201 in FIG. 2, and a terminal which is connected to another terminal is the printer 202 in FIG. 2. In addition, configurations of the camera 201 and the printer 202 are described using the configuration of the communication terminal 100 illustrated FIG. 1.

In the printer 202 which is connected to another terminal, the communication controller 102 periodically transmits a beacon using a broadcast by way of the WLAN module 103. This beacon comprises a MAC address of the printer 202 as information to identify the printer 202. The communication controller 102 which connects to another terminal receives the beacon by way of the WLAN module 103. In addition, the communication controller 102 of the camera 201 recognizes the existence of the printer 202, based on the MAC address of the printer 202 which is included in the beacon (Step S101).

If the connection setting button 201-BT (connection setting button 101) of the camera 201 is pressed, the communication controller 102 of the camera 201 transmits a probe request to the printer 202 by way of the WLAN module 103. The probe request indicates a connection request of a wireless communication. This probe request comprises first information which indicates that it is a connection by the PBC. The probe request comprises second information which indicates that the camera 201 has asked to connect as the registrar (a first side terminal which authenticates a connected terminal), or has asked to connect as the enrollee (a second side terminal which is authenticated by the first side terminal), or has asked to connect as either of the registrar or the enrollee.

The communication controller 102 of the printer 202 receives the probe request from the camera 201 by way of the WLAN module 103. Next, the communication controller 102 of the printer 202 determines whether or not it is able to connect with the printer 202 and the camera 201, based on a communication condition by wired or wireless communication of the printer 202, and information included in the probe request (Step S103). In this determination, the communication controller 102 also determines whether the camera 201 or the printer 202 should become the registrar or the enrollee. A detailed description of this determination process is explained below.

If it is determined that it is able to connect with the printer 202 and the camera 201, the communication controller 102 makes the LED 104 irradiate. Therefore, the user is able to know that a connection will be established if the user presses the connection setting button 202-BT (connection setting button 101) of the printer 202. In addition, if it is determined that it is not able to connect, the communication controller 102 does nothing, and maintains its current state. After determining that it is able to connect with the printer 202 and the camera 201, and when the connection setting button 202-BT of the printer 202 is pressed, the communication controller 102 transmits a probe response, which is a response to the probe request, to the camera 201 by way of the WLAN module 103 (Step S104). This probe response comprises information which indicates that the camera 201 or the printer 202 is the registrar or the enrollee. In FIG. 4, the printer 202 is the registrar, and the camera 201 is the enrollee.

The communication controller 102 of the camera 201 receives the probe response from the printer 202 by way of the WLAN module 103. The communication controller 102 of the camera 201 recognizes that the camera 201 becomes the enrollee, based on the information included in the probe response (Step S105). Afterward, in the same way as in the connection process of the normal WPS, an exchange of a public key (Step S106), and a series of processes about an authentication (Step S107) are performed sequentially, and a setting for a connection is completed. Regarding as the authentication, for example, the communication controller 102 of the printer 202 authenticates by determining whether or not the MAC address which coincides with preliminary registered MAC address is notified from the camera 201.

Afterwards, at both the camera 201 and the printer 202, a message which indicates that the connection is completed is displayed on the LCD 106 (Step S108).

In the above-mentioned process, the printer 202 transmits the beacon, but the camera 201 may transmit the probe request using a broadcast, instead of transmitting the beacon by the printer 202. In this case, the printer 202 recognizes the existence of the camera 201 based on the probe request which is broadcasted, and transmits the probe response to the camera 201.

In the case of FIG. 3, both the router 302 and the printer 303 perform the process of the terminal (shown in FIG. 4), which is connected to another terminal. Hereby, if the router 302 determined that it is able to connect and the connection setting button 302-BT is irradiated, but if the printer 303 determines that it is not able to connect, and the connection setting button 303-BT is not irradiated.

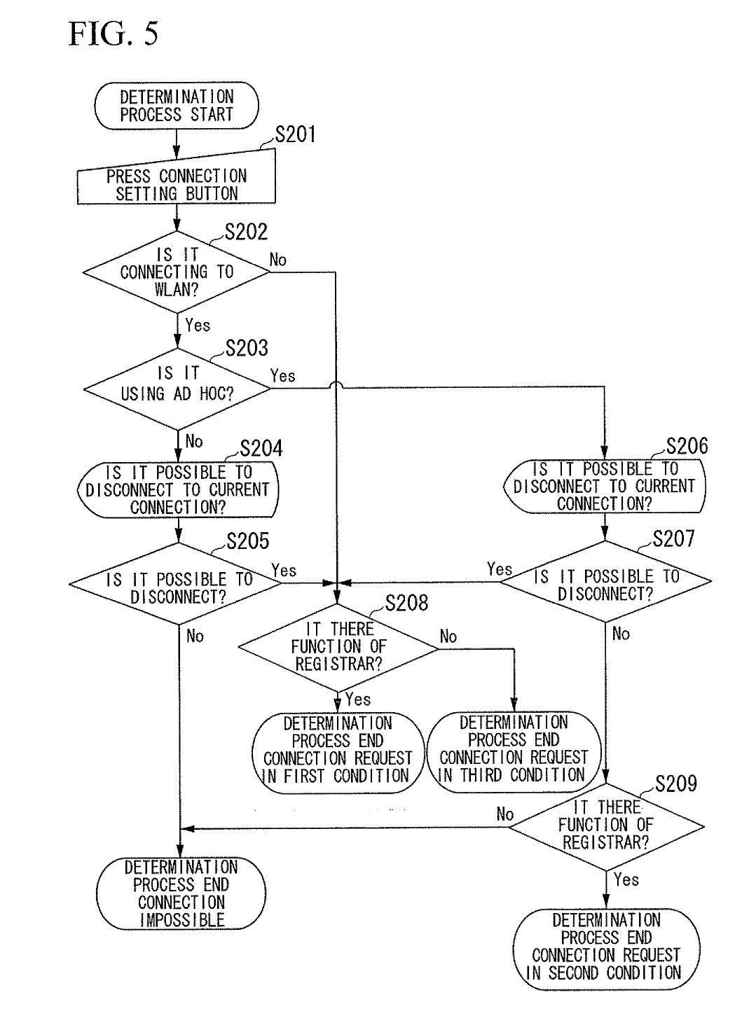

Next, a determination process which is performed by the communication terminal 100 (the terminal, shown in FIG. 4, which connects to another terminal) which generates the probe request is explained with reference to FIG. 5. FIG. 5 shows a process in which the communication terminal 100 determines whether or not the communication terminal is able to connect to another terminal, based on a communication condition of the communication terminal 100 and whether or not the communication terminal 100 has a function of the registrar.

As a result of the determination process of FIG. 5, one of four different results ((1) connection impossible, (2) request to connect in a first condition, (3) request to connect in a second condition, (4) request to connect in a third condition) is obtained. The first condition indicates that a terminal is able to become both the registrar and the enrollee. The second condition indicates that a terminal is not able to become the enrollee, but is able to become the registrar. The third condition indicates that a terminal in not able to become the registrar, but is able to become the enrollee.

At first, if the connection setting button 101 is pressed (Step S201), the communication controller determines whether or not the WLAN module 103 is connecting to another communication terminal (Step S202). If the WLAN module 103 is not connecting to another terminal, a process of step S208 is performed. In addition, if the WLAN module 103 is connecting to another terminal, the communication controller 102 determines whether kind of a connection is an ad hoc connection or an infrastructure connection (step S203).

If the connection is the infrastructure connection (“No” in step S203), the communication controller 102 displays a message which indicates whether or not it is possible to disconnect to a current connection, and urges a user to operate (step S204). If the user operates the setting switch 105 and information which indicates whether or not it is possible to disconnect to the connection, the communication controller 102 determines whether or not it is possible to disconnect to the current connection (step S205).

If it is not able to disconnect to the current connection, the communication controller 102 determines that it is not able to disconnect, and finishes the determination process. In addition, if it is possible to disconnect to the current connection, the communication controller 102 determines whether or not the communication terminal 100 has a function of the registrar (step S208).

If the communication terminal 100 has the function of the registrar, the communication controller 102 determines that the communication terminal 100 requires to connect in the first condition, and finishes the determination process. If the communication terminal 100 does not have the function of the registrar, the communication controller 102 determines that the communication terminal 100 requires to connect in the connection 3, and finishes the determination process.

If the connection is the ad hoc connection (“Yes” in step S203), the communication controller 102 displays a message, which indicates whether or not it is possible to disconnect to the current connection, on the LCD 106, and urges the user to operate (step S206). If the user operates the setting switch 105, and information which indicates that it is possible to disconnect to the current connection is inputted to the communication terminal 100, the communication controller 102 determines whether or not it is possible to disconnect to the current connection (step S207).

If it is possible to disconnect to the current connection, the above-mentioned process of step S208 is performed. In addition, if it is not able to disconnect to the current connection, the communication controller 102 determines whether or not the communication terminal 100 has the function of the registrar (step S209). If the communication terminal 100 has the function of the registrar, the communication controller 102 determines whether or not the communication terminal 100 connects in second condition, and finishes the determination process. In addition, if the communication terminal 100 does not have the function of the registrar, the communication controller 102 determines that it is not able to disconnect to the connection, and finishes the determination process.

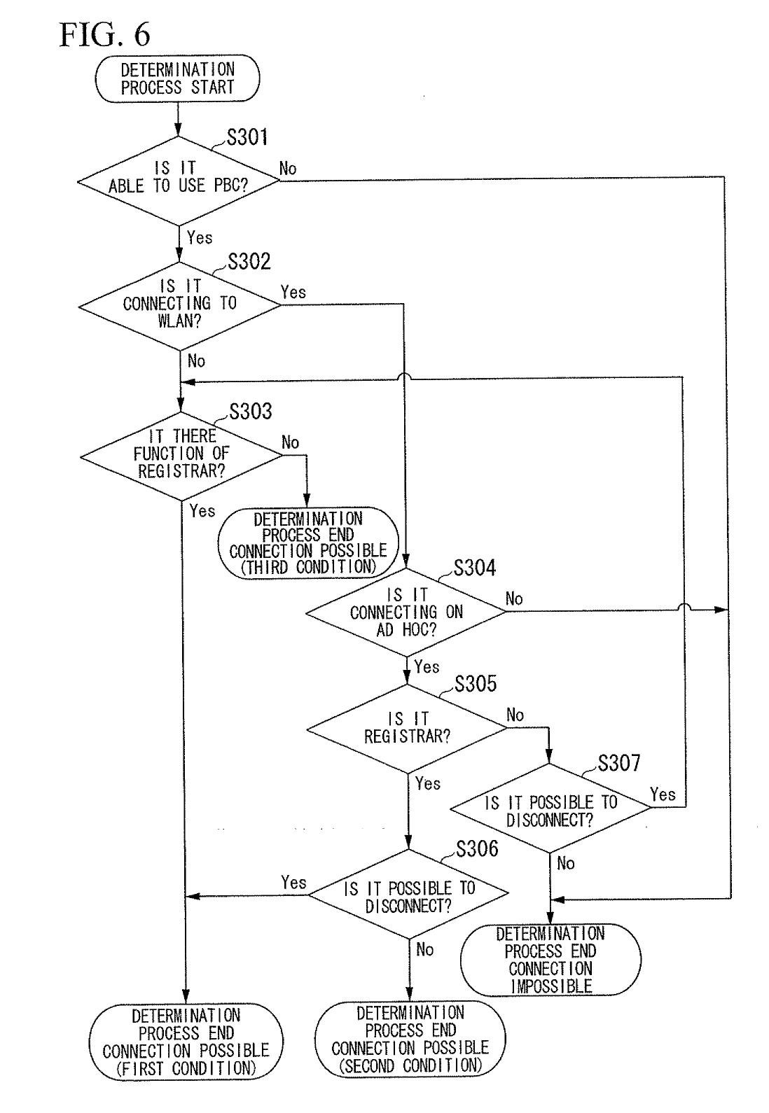

Next, a determination process performed by communication terminal 100 (the terminal in FIG. 4 which is connected to another terminal), which is reception side of a probe request, with reference to FIG. 6. FIG. 6 shows process the communication terminal 100 determines whether or not it is able to connect, based on a communication condition of the communication terminal 100 and whether or not the communication terminal 100 has a function of the registrar. The first, second and third conditions shown in FIG. 6 are the same respectively as first, second and third conditions shown in FIG. 5.

If the probe request is received, the communication controller 102 determines whether the communication terminal 100 accommodates a connection setting of the PBC (step S301). If the communication terminal 100 does not accommodate the connection setting of the PBC, the communication controller determines that it is not able to connect, and finishes the determination process. In addition, if the communication terminal 100 accommodates the connection setting of the PBC, the communication controller 102 determines whether or not the WLAN module 103 is connecting to another communication terminal (step S302).

If the WLAN module 103 is not connecting to another communication terminal (“No” in step S302), the communication controller 102 determines whether or not the communication terminal 100 has a function of the registrar (step S303). If the communication terminal 100 has the function of the registrar, the communication controller 102 determines the communication terminal 100 connects in the first condition, and finishes the determination process. In addition, if the communication terminal 100 does not have the function of the registrar, the communication controller 102 determines the communication terminal 100 connects in the third condition, and finishes the determination process.

If the WLAN module 103 is connecting to another communication terminal (“Yes” in step S302), the communication controller 102 determines whether connection is the ad hoc connection or the infrastructure connection (step S304). If the connection is the infrastructure connection (“No” in step S304), the communication controller 102 determines that it is not able to connect, and finishes the determination process. In addition, if the connection is the ad hoc connection (“Yes” in step S304), the communication controller 102 determines whether or not the communication terminal 100 connects as the registrar (step S305).

If the communication terminal 100 connects as the registrar (“Yes” in step S305), the communication controller 102 determines whether or not the communication terminal 100 is possible to disconnect to a current connection (step S306).

This determination is performed based on preliminary set information (for example, information which indicates that it is possible to disconnect if it is not performing a communication, information which indicates that it is always able to disconnect, or information which indicates that it is not able to disconnect). If the communication terminal 100 is possible to disconnect to the current connection, the communication controller 102 determines the communication terminal 100 connects in the first condition, and finishes the determination process. In addition, if the communication terminal 100 is not able to disconnect to the current connection, the communication controller determines the communication terminal 100 connects in the second condition, and finishes the determination process.

In addition, if the communication terminal 100 is connecting as the enrollee (“No” in step S305), the communication controller 102 determines whether or not the communication terminal 100 is possible to disconnect to the current connection (step S307). This determination is performed based on like the above-mentioned information. If the communication terminal 100 is possible to disconnect to the current connection, the above-mentioned process of step S303 is performed. In addition, if the communication terminal 100 is not able to disconnect to the current connection, the communication controller 102 determines the communication terminal 100 is not able to disconnect, and finishes the determination process.

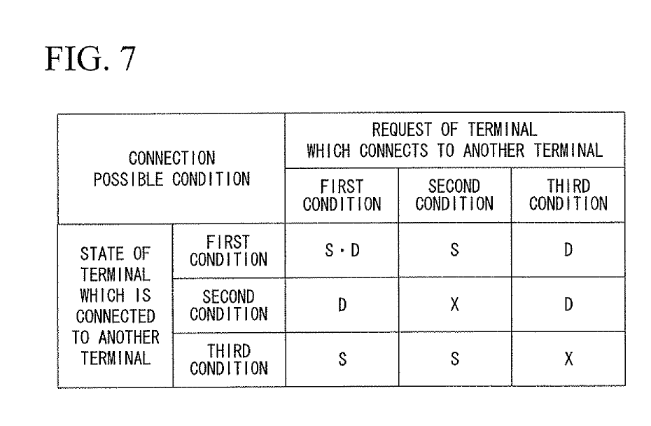

Next, a final determination process performed by the communication terminal 100 is explained with reference to FIG. 7. In the determination processes of FIG. 5 and FIG. 6, the communication terminal, which is a main body of the determination, determines whether or not the communication terminal 100 is able to connect, based on a communication condition and information which indicates that the communication terminal 100 has the function of the registrar, and not based on a condition of the communication terminal, which the communication terminal 100 is connecting to. Finally, based on this determination result, it is determined whether or not it is able to connect, and which communication terminal 100 is able to become the registrar or the enrollee, based on both conditions of the communication terminal 100 (the terminal which requests to connect) and another communication terminal 100 (the terminal which is requested to connect). In FIG. 4, the terminal (printer 202), which connects to another terminal, and which receives the probe request, performs this final determination process.

FIG. 7 shows which terminal is able to become the registrar or enrollee, based on a combination of connection condition, which is obtained by the determination process of FIG. 5, of the terminal which connects to another terminal, and the connection condition, which is obtained by the determination process of FIG. 6, of the terminal which is connected to another terminal. In FIG. 7, a code S indicates that a first terminal, which connects to a second terminal, becomes the registrar (the second terminal, which is connected to the first terminal, is the enrollee). A code D indicates that the second terminal, which is connected to the first terminal, becomes the registrar (the first terminal, which connects to the second terminal, is the enrollee). In addition, a code X indicates that a connection between the first terminal and the second terminal is impossible.

For example, if the first terminal requests to connect in the first condition, and the second terminal is able to connect to the first terminal in the first condition, both the first terminal and second terminal are able to become the registrar or the enrollee. In addition, the first terminal requests to connect in the second condition, and the second terminal is able to connect to the first terminal in the first condition, the first terminal becomes the registrar, and the second terminal becomes the enrollee. In addition, the first terminal requests to connect in the third condition, and the second terminal is able to connect to the first terminal in the first condition, the second terminal becomes the registrar, and the first terminal becomes the enrollee. In other cases, it is similar to above.

In FIG. 4, in step S102, the communication controller 102, which connects to another terminal, performs the determination process showed FIG. 5. In addition, in step S103, the communication controller 102 of the terminal, which is connected to another terminal, performs the determination process showed FIG. 6, and the final determination process based on the connection condition showed FIG. 7. If it is determined that a connection is impossible, the connection setting button 101 of the terminal, which is connected to another terminal, does not irradiate, but in other cases, the connection setting button 101 irradiates. If it is determined that the connection is impossible, the wireless connection process between the first terminal, which connects to the second terminal, and the second terminal, which is connected to the first terminal, is suspended.

In the above-mentioned description, the method of irradiating the button is used, as the method of notifying to the user which buttons of the terminals the user should press, but other method may be used. For example, a method where the LCD 106 displays a message may be used. In this method, in the step S103 of FIG. 4, the communication controller 102 of the terminal, which is connected to another terminal, outputs, to the LCD 106, information of the determination result which indicates whether or not it is able to connect, and displays a message on the LCD 106. In FIG. 4, the user is able to know that a connection will be established if the user presses the connection setting button 101 of the terminal, which is connected to another terminal, by looking at a display of the LCD 106 of the terminal, which is connected to another terminal.

Displaying the message may be performed not by the terminal, which is connected to another terminal, but by the terminal, which connects to another terminal. For example, in the step S103 of FIG. 4, the communication controller 102 of the terminal, which is connected to another terminal, transmits information regarding a determination result which indicates whether or not it is able to connect, to the terminal, which connects to another terminal, by way of the WLAN module 103. The communication controller 102 of the terminal, which connects to another terminal, receives this information by way of the WLAN module 103, and displays a message on the LCD 106 similar to the above-mentioned description. The user is able to know that a connection will be established if the user presses the connection setting button 101 of the terminal, which is connected to another terminal, by looking at the LCD 106 of the terminal, which connects to another terminal.

In addition, a method of notifying the user by sound may be used as another method of notifying the user which button of terminals the user should press. Also, when this method is used, sound output is performed by the terminal, which is connected to another terminal, or the terminal, which connects to another terminal.

As described above, according to this embodiment, the communication terminal (the terminal which is transmitted the connection request of the wireless communication, and which is connected to another terminal, in FIG. 4) determines whether or not wireless communication connection to the terminal (the terminal which transmits the connection request) is possible, based on the information on the communication condition of the communication terminal, information from the communication terminal (the terminal, which connects to another terminal, in FIG. 4) which transmits the connection request, and information which indicates whether or not the communication terminal has the function of the registrar. The information based on the determination result is notified from the communication terminal, which transmits or is transmitted the connection request, to the user. Therefore, even if there are a plurality of communication terminals which is able to become a connection object using the wireless communication (in case of FIG. 3), the determination results, which indicates whether it is able to connect to the wireless connection, relating each communication terminals (router 302, printer 303 in FIG. 3) are notified to the user. Therefore, the user is able to know which terminals the user should connect to the wireless communication.

In addition, the communication terminal (the terminal of FIG. 4 which connects to another terminal) which received the beacon transmits the information which indicates whether or not the communication terminal has the function of the authentication, to a communication terminal (the terminal of FIG. 4 which connects to another terminal) which transmits the beacon. Therefore, the communication terminal which transmits the beacon is able to determine which communication terminals perform the authentication, based on this information and the information which indicates whether or not the communication terminal has the function of the authentication. Therefore, it is able to suitably determine the communication terminal which authenticates, and the communication terminal which is authenticated, and is possible to improve a possibility of establishing the wireless communication connection.

When a communication terminal which newly tries to connect, has already established a connection to another communication terminal, the possibility of establishing the communication is restricted. Therefore, disconnecting to the connection with another communication terminal and establishing a new connection, improves the possibility of a connection. Therefore, in the determination processes shown in FIG. 5 and FIG. 6, it determines whether or not to disconnect to the already established connection, and when it determines that it disconnects to the connection, it establishes a new connection. Then, the possibility of establishing the connection is able to be improved.

In addition, according to the process shown in FIG. 4, after the first terminal (the terminal which connects to another terminal) receives the beacon from the second terminal (the terminal which is connected to another terminal) and the first terminal receives the frame response from the second terminal, the first terminal performs a connection process only one time between the first terminal and the second terminal. Therefore, it is determined whether or not it is possible to connect or disconnect, and whether the terminals become the registrar or the enrollee. Therefore, it is able to perform a connection setting in short time.

While an embodiment of the present invention has been described above in detail with reference to the drawings, the specific configuration thereof is not limited to this embodiment. Designs and the like without departing from the spirit or scope of this invention are also included.

1. A communication terminal comprising:
a determination unit which determines whether or not the communication terminal is able to connect to a first external terminal using a wireless communication, based on a communication condition of wired or wireless communication with a second external terminal which is different from the first external terminal, when the communication terminal receives a connection request from the first external terminal.

2. A communication terminal comprising:
a reception unit which receives a connection request of a wireless communication from a first external terminal;
a determination unit which determines whether or not the communication terminal is able to connect to the first external terminal using the wireless communication, based on a communication condition of wired or wireless communication with a second external terminal which is different from the first external terminal, when the reception unit receives the connection request; and
a notification unit which notifies information to a user, based on a determination result of the determination unit.

3. The communication terminal according to claim 2, wherein
the reception unit further receives first information which indicates that the first external terminal is able to become a first side which authenticates a connected terminal or a second side which is authenticated by the first side,
the determination unit determines whether the communication terminal is able to connect to the first external terminal using the wireless communication or not, based on the first information, a second information that indicates that the communication terminal is able to become the first side or the second side, and a third information on the communication condition.

4. The communication terminal according to claim 2, wherein
the determination unit sets the first external terminal to the second side, and sets the self communication terminal to the first side, when there is satisfied at least one of the following conditions:
the first information indicates that the first external terminal is able to become both the first and second side, and the second information indicates that the communication terminal is able to become the first side;
the first information indicates that the first external terminal is able to become the second side, and the second information indicates that the communication terminal is able to become the first side; and
the first information indicates that the first external terminal is able to become the second side, and the second information indicates that the communication terminal is able to become both the first and second side.

5. The communication terminal according to claim 2, wherein
the determination unit sets the first external terminal to the first side, and sets the communication terminal to the second side, when there is satisfied at least one of the following conditions:
the first information indicates that the first external terminal is able to become both the first and second side, and the second information indicates that the communication terminal is able to become the second side;
the first information indicates that the first external terminal is able to become the first side, and the second information indicates that the communication terminal is able to become the second side; and
the first information indicates that the first external terminal is able to become the first side, and the second information indicates that the communication terminal is able to become both the first and second side.

6. The communication terminal according to claim 2, wherein
the determination unit sets the first external terminal to one of the first or second side, and sets the communication terminal to the other of the first or second side,
when the first information indicates that the first external terminal is able to become both the first and second side, and the second information indicates that the communication terminal is able to become both the first and second side.

7. The communication terminal according to claim 2, wherein
the determination unit suspends a connecting process with the first external terminal, when there is satisfied at least one of the following conditions:
the first information indicates that the first external terminal is able to become the first side, and the second information indicates that the communication terminal is able to become the first side; and
the first information indicates that the first external terminal is able to become the second side, and the second information indicates that the communication terminal is able to become the second side.

8. A communication terminal comprising:
a reception unit which receives a connection request of a wireless communication from a first external terminal;
a determination unit which determines whether or not the communication terminal is able to connect to the first external terminal using the wireless communication, based on a communication condition of wired or wireless communication with a second external terminal which is different from the first external terminal, when the reception unit receives the connection request; and
a transmission unit which transmits information to the first external terminal based on a determination result of the determination unit.

9. The communication terminal according to claim 8, wherein
the reception unit further receives first information which indicates that the first external terminal is able to become a first side which authenticates a connected terminal or a second side which is authenticated by the first side,
the determination unit determines whether the communication terminal is able to connect to the first external terminal using the wireless communication or not, based on the first information, a second information that indicates that the communication terminal is able to become the first side or the second side, and a third information on the communication condition.

10. The communication terminal according to claim 8, wherein
the determination unit sets the first external terminal to the second side, and sets the communication terminal to the first side, when there is satisfied at least one of the following conditions:
the first information indicates that the first external terminal is able to become both the first and second side, and the second information indicates that the communication terminal is able to become the first side;
the first information indicates that the first external terminal is able to become the second side, and the second information indicates that the communication terminal is able to become the first side; and
the first information indicates that the first external terminal is able to become the second side, and the second information indicates that the communication terminal is able to become both the first and second side.

11. The communication terminal according to claim 8, wherein
the determination unit sets the first external terminal to the first side, and sets the communication terminal to the second side, when there is satisfied at least one of the following conditions:
the first information indicates that the first external terminal is able to become both the first and second side, and the second information indicates that the communication terminal is able to become the second side;
the first information indicates that the first external terminal is able to become the first side, and the second information indicates that the communication terminal is able to become the second side; and
the first information indicates that the first external terminal is able to become the first side, and the second information indicates that the communication terminal is able to become both the first and second side.

12. The communication terminal according to claim 8, wherein
the determination unit sets the first external terminal to one of the first or second side, and sets the communication terminal to the other of the first or second side,
when the first information indicates that the first external terminal is able to become both the first and second side, and the second information indicates that the communication terminal is able to become both the first and second side.

13. The communication terminal according to claim 8, wherein
the determination unit suspends a connecting process with the first external terminal, when there is satisfied at least one of the following conditions:
the first information indicates that the first external terminal is able to become the first side, and the second information indicates that the communication terminal is able to become the first side; and
the first information indicates that the first external terminal is able to become the second side, and the second information indicates that the communication terminal is able to become the second side.

14. The communication terminal according to claim 2, wherein
the determination unit determines whether the communication terminal is able to connect to the first external terminal using the wireless communication, based on whether the communication terminal is communicating with the second external terminal by wired or wireless communication.

15. The communication terminal according to claim 14, wherein
the determination unit determines whether the communication terminal is able to connect to the first external terminal using the wireless communication, based on which an ad hoc mode or an infrastructure mode the communication terminal uses and communicates with the second external terminal, when the communication terminal is communicating with the second external terminal by wired or wireless communication.

16. The communication terminal according to claim 15, wherein
the determination unit determines whether or not the communication terminal is able to connect to the first external terminal using the wireless communication, based on the communication terminal is possible to disconnect to the second external terminal, when the self communication terminal uses the ad hoc mode, and communicates the second external terminal.

17. A communication terminal comprising:
a transmission unit which transmits a connection request to a first external terminal, wherein
the first external terminal comprises:
a reception unit which receives the connection request of a wireless communication from the communication terminal;
a determination unit which determines whether or not the first external terminal is able to connect to the communication terminal using the wireless communication, based on a communication condition of wired or wireless communication with a second external terminal which is different from the communication terminal, when the reception unit receives the connection request; and
a notification unit which notifies information to a user, based on a determination result of the determination unit.

18. The communication terminal according to claim 17, wherein
the transmission unit further transmits, to the first external terminal, information which indicates that the communication terminal is able to become a first side which authenticates a connected terminal or a second side which is authenticated by the first side.

19. A communication terminal comprising:
a first transmission unit which transmits a connection request to a first external terminal;
a first reception unit which receives information based on a determination result from the first external terminal; and
a notification unit which notifies information based on the determination result to a user,
the first external terminal comprising:
a second reception unit which receives a connection request of a wireless communication from the communication terminal;
a determination unit which determines whether or not the first external terminal is able to connect to the communication terminal using the wireless communication, based on a communication condition of wired or wireless communication with a second external terminal which is different from the communication terminal, when the second reception unit receives the connection request; and
a second transmission unit which transmits, to the communication terminal, information based on the determination result of the determination unit.

20. The communication terminal according to claim 19, wherein
the first reception unit further receives, from the first external terminal, information which indicates that the first external terminal is able to become a first side which authenticates a connected terminal or a second side which is authenticated by the first side,
the determination unit determines whether the first external terminal is able to connect to the communication terminal based on second information which indicates that the first external terminal is able to become the first side or second side, the first information, and a communication condition,
the second transmission unit further transmits the first information to the communication terminal.

21. A communication system provided with a first communication terminal and a second communication terminal,
the first communication terminal comprising:
a reception unit which receives a connection request of a wireless communication from the second communication terminal;
a determination unit which determines whether or not the first communication terminal is able to connect to the second communication terminal using the wireless communication, based on a communication condition of wired or wireless communication with a third communication terminal which is different from the second communication terminal, when the reception unit receives the connection request; and
a notification unit which notifies information to a user, based on a determination result of the determination unit,
the second communication terminal comprising:
a transmission unit which transmits the connection request to the first communication terminal.

22. A communication system provided with a first communication terminal and a second communication terminal,
the first communication terminal comprising:
a first reception unit which receives a connection request of a wireless communication from the second communication terminal;
a determination unit which determines whether or not the first communication terminal is able to connect to the second communication terminal using the wireless communication, based on a communication condition of wired or wireless communication with a communication terminal which is different from the second communication terminal, when the first reception unit receives the connection request; and
a first transmission unit which transmits information to the second communication terminal, based on a determination result of the determination unit,
the second communication terminal comprising:
a second transmission unit which transmits the connection request to the first communication terminal;
a second reception unit which receives information based on the determination result from the first communication terminal; and
a notification unit which notifies information to a user, based on the determination result.

23. A determination method of a communication terminal comprising:
determining whether or not the communication terminal is able to connect to a first external terminal using a wireless communication, based on a communication condition of wired or wireless communication with a second external terminal which is different from the first communication terminal, when the communication terminal receives a connection request from the first external terminal.

24. The communication terminal according to claim 8, wherein
the determination unit determines whether the communication terminal is able to connect to the first external terminal using the wireless communication, based on whether the communication terminal is communicating with the second external terminal by wired or wireless communication.
